(19) United States
(12) Patent Application Publication
(10) Pub. No.: US 2015/0049472 A1
(43) Pub. Date: Feb. 19, 2015

(54) LAMP STAND WITH FAUX FLAME

(71) Applicant: Wen-Cheng LAI, Taoyuan Hsien (TW)

(72) Inventor: Wen-Cheng LAI, Taoyuan Hsien (TW)

(21) Appl. No.: 13/968,997

(22) Filed: Aug. 16, 2013

(51) Int. Cl. F21S 10/04; F21S 9/00; F21V 23/00; F21S 6/00

(52) U.S. Cl. CPC F21S 10/046; F21S 6/001; F21S 9/00; F21V 23/002; F21W 2121/00
USPC 362/186; 362/188

(57) ABSTRACT

A lamp stand with faux flame is provided, including a lamp base, support frame, flame holder, flame flake, light-emitting body, power supply, driving device, impact arm and driving circuit; wherein power supply disposed inside lamp base; support frame standing upon lamp base; flame holder connected to support frame and having a vertical via hole; flame flake penetrating via hole and protruding beyond top of flame holder; light-emitting body fixed to flame holder and emitting light towards direction of flame flake; light-emitting body connected to power supply; driving device fixed to lamp base; one end of impact arm connected to driving device output. The driving circuit and power supply are connected and drive output end of the driving device to suck in or bounce out to generate a propulsion, making impact arm to hit flame flake. The present invention can replace conventional candle to achieve visual effect of flickering flame.

### FIELD OF THE INVENTION

The present invention generally relates to a lamp technique, and more specifically to a lamp with visual effect of faux flame.

### BACKGROUND OF THE INVENTION

While the traditional candle and oil-lamp are no longer in wide use, the traditional meaning and unique ambience associated with candle and oil lamp are still irreplaceable by the modern light bulb lamp. In particular, in many religious rituals, burning incense, candle or oil lamp is still considered as part of the important auspicious offering for spiritual cleansing. In addition, the flickering flame on the candle stick or oil lamp is considered to have a calming effect to soothe the weariness and fatigue for various occasions. However, as the candle and oil lamp poses potential danger if not carefully handled, the lamps with faux flame are developed. Therefore, many lamps with faux flame are developed to play the conventional role of the candle.

The known lamp with faux flame is usually made into a shape of candle stand, with a flame-shape shade or bulb. A light-emitting body is placed inside the flame-shaped shade or bulb. When supplied with power, the light-emitting body inside the flame-shaped shade or bulb will emit light and the light radiates from the flame-shaped shade or bulb to create a visual effect of the lighted flame. However, as the flame created by the flame-shaped shade or bulb appears fixed, the visual effect is far from satisfactory to emulate the realistic effect of an actual flame.

Thus, it is desirable to devise a lamp with realistic faux flame to replace the actual candle and oil lamp while maintenance realistic visual result.

### SUMMARY OF THE INVENTION

The primary object of the present invention is to provide a lamp with realistic faux flame to replace the actual candle and oil lamp while maintenance realistic visual result.

To achieve the above object, the present invention provides a lamp stand with faux flame, including a lamp base, a support frame, a flame holder, a flame flake, a light-emitting body and a power supply. The power supply is disposed inside the lamp base; the support frame is fixedly standing upon the lamp base; the flame holder is fixedly connected to the top of the support frame and having a vertical via hole; the flame flake penetrates the via hole and protrudes beyond the top of the flame holder; the light-emitting body is fixed to the flame holder and emits light towards the direction of the flame flake. The light-emitting body is electrically connected to the power supply. The lamp stand with faux flame further includes a driving device, an impact arm and a driving circuit. The driving device is fixed to the lamp base. One end of the impact arm is connected to the output end of the driving device. The driving circuit and the power supply are electrically connected and drive the output end of the driving device to suck in or bounce out to generate a propulsion, which in turn makes the impact arm to hit the flame flake.

Preferably, the driving device is a relay or an electromagnetic coil.

Preferably, the upper end of the impact arm is disposed with an impact head; when the impact arm hits the flame flake, the impact head contacts the power end of the flame flake to cause the flame flake to sway.

Preferably, the impact arm hits the lower end of the flame flake intermittently.

Preferably, the lamp stand with faux flame further includes a lamp shade. The lamp shape has an opening at the top. The lamp shade covers on the outside of the lamp base, the support frame and the flame holder. The flame flake passes through the opening and extends beyond the lamp shade. The lamp shade can provide protection to the lamp base, the support frame and the flame holder, as well as additional aesthetic effect to enhance the realistic visual effect of a flame.

Compared to known technique, the present invention includes a flame flake hanging in the flame holder and a light-emitting body on the flame holder to emit light towards the flame flake to create a visual effect of flickering flame. By using the driving circuit to driving the driving device so that the driving device can operate intermittently to drive the impact arm to hit the flame flake so that the flame flake can sway to display a visual effect of flickering flame. In addition, because the driving circuit drives the driving device intermittently, no large current is required to continuously operate. As such, the energy-consumption is reduced to save the operation cost.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of a lamp stand with faux flame of the first embodiment according to the present invention;

FIG. 2 shows a cross-sectional view of the flame holder and the flame flake of the lamp stand with faux flame of the first embodiment according to the present invention;

FIG. 3 shows a schematic view of a lamp stand with faux flame of the second embodiment according to the present invention; and

FIG. 4 shows a schematic view of a lamp stand with faux flame of the third embodiment according to the present invention.

### DETAILED DESCRIPTION OF THE PREFERRED EMBODIMENTS

The following refers to the drawings to describe the preferred embodiments of the present invention.

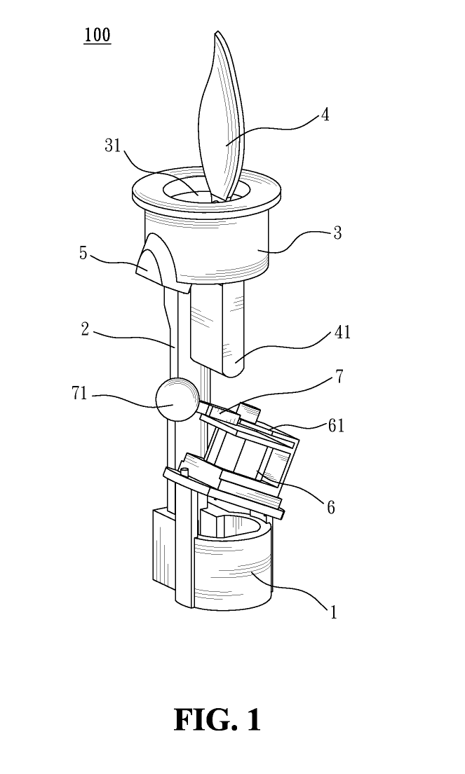

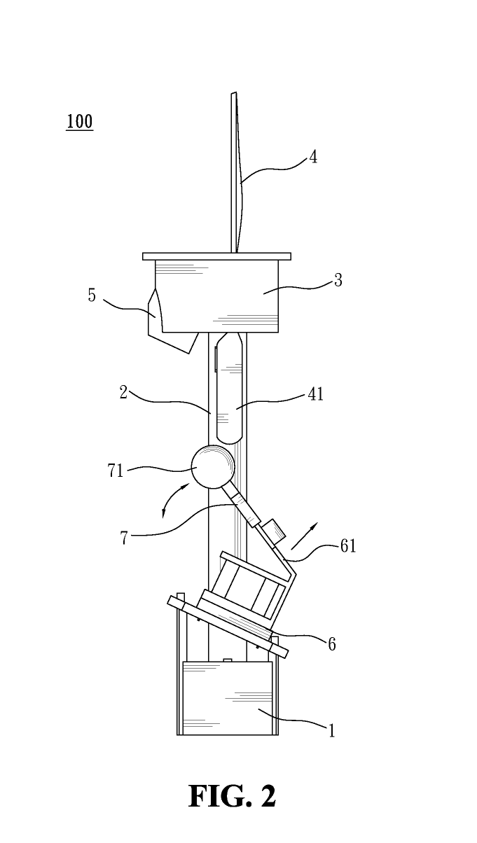

As shown in FIG. 1 and FIG. 2, a lamp stand with faux flame 100 of the present invention includes: a lamp base 1, a support frame 2, a flame holder 3, a flame flake 4, a light-emitting body 5, a power supply (not shown), a relay 6, an impact arm 7, a driving circuit (not shown), and a lamp shade (not shown). The power supply is disposed at the lower part of the lamp base 1; the support frame 2 is fixedly standing upon the lamp base 1; the flame holder 3 is fixedly connected to the top of the support frame 2 and having a vertical via hole 31; the flame flake 4 penetrates the via hole 31 and protrudes beyond the top of the flame holder 3; the light-emitting body 5 is fixed to the flame holder 3 and emits light towards the direction of the flame flake 4. The light-emitting body 5 is electrically connected to the power supply. The relay 6 is disposed at the lamp base 1. The output end of the relay 6 is a spring stripe 61, which is sucked in or bounced out intermittently due to the current running through the iron core of the relay 6. One end of the impact arm 7 is fixedly connected to the spring stripe 61. The driving circuit is disposed inside the lamp base 1 and is electrically connected to the power supply. The driving circuit drives the relay 6 to actuate the spring strip 61, which in turn actuates the impact arm 7 to hit the flame flake 4.

Also as shown in FIG. 1, specifically, the upper end of the impact arm is disposed with an impact head 71. When the impact arm 7 hits the flame flake 4, the impact arm 71 contacts the lower end 41 of the flame flake 4. The impact head 71 is made of a soft or resilient material. As such, a buffering effect can be obtained when hitting the flame flake 4 to avoid strong impact on the lower end 41 of the flame flake 4.

The lamp shape has an opening at the top. The lamp shade covers on the outside of the lamp base 1, the support frame 2 and the flame holder 3. The flame flake 4 passes through the opening and extends beyond the lamp shade. The lamp shade can provide protection to the lamp base 1, the support frame 2 and the flame holder 3, as well as additional aesthetic effect to enhance the realistic visual effect of a flame.

In summary of the above description and FIGS. 1 and 2, when the switch of the lamp stand with faux flame100 is turned on, the light-emitting body 5 emits light onto the side of the flame flake 4. Also, the driving device 7 is connected intermittently to cause the iron core of the relay 6 to intermittently generate a propulsion to suck in or bounce out the spring stripe 61. During sucking in or bouncing out the spring stripe 61, the spring stripe 61 actuates the impact arm 7 to move so that the impact head 71 reaches the lower end 41 of the flame flake 4 to make push the flame flake 4 to sway, which creates a visual effect of flickering flame.

Compared to known technique, the present invention includes a flame flake 4 hanging in the flame holder 3 and a light-emitting body 5 on the flame holder 3 to emit light towards the flame flake 4 to create a visual effect of flickering flame. By using the driving circuit to driving the relay 6 so that the relay 6 can operate intermittently to drive the impact arm to hit the flame flake so that the flame flake can sway to display a visual effect of flickering flame. In addition, because the driving circuit drives the relay 6 intermittently, no large current is required to continuously operate. As such, the energy-consumption is reduced to save the operation cost.

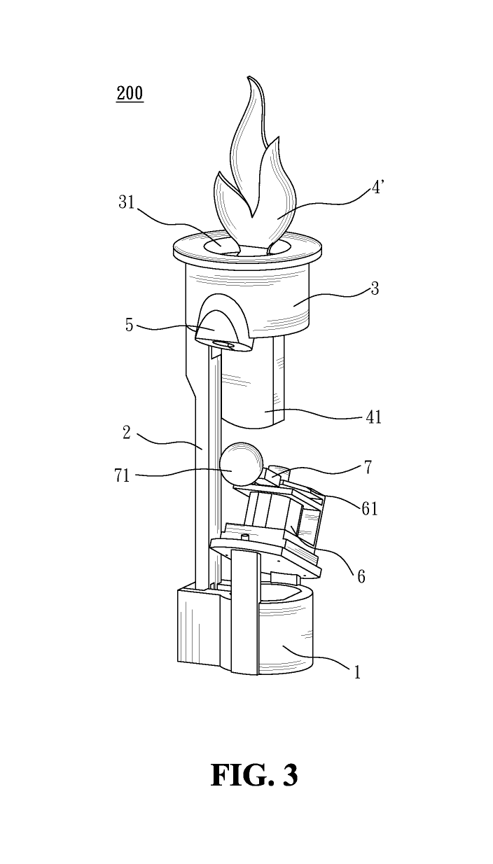

As shown in FIG. 3, FIG. 3 shows a schematic view of a lamp stand with faux flame 200 of the second embodiment according to the present invention. The structure of the lamp stand with faux flame 200 is the same as the structure of the first embodiment, with the exception that the flame flake 4′ can include a plurality of flakes loosely assembled to create more vivid flame effect.

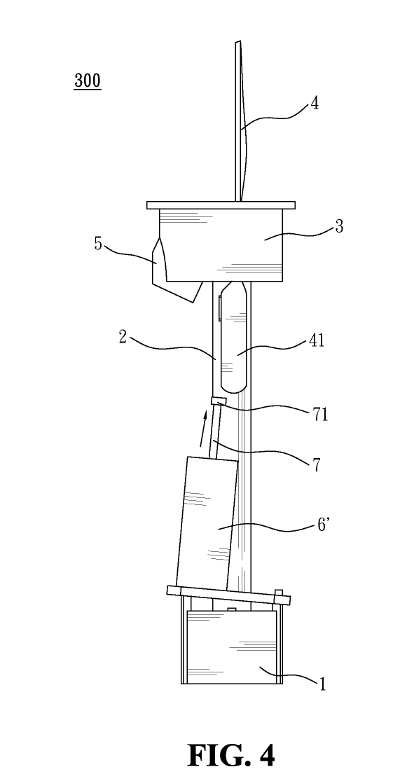

As shown in FIG. 4, FIG. 4 shows a schematic view of a lamp stand with faux flame 300 of the third embodiment according to the present invention. The structure of the lamp stand with faux flame 300 is the same as the structure of the first embodiment, with the exception that the driving device is an electromagnetic coil 6′. The electromagnetic coil 6′ is electrically connected to the driving circuit and the driving circuit intermittently drives the current running through electromagnetic coil to generate propulsion, which actuates the tip of the impact head 71 to hit the lower end of the flame flake 4 so that the flame flake 4 sway to create a visual effect of a flame flickering.6′

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A lamp stand with faux flame, including a lamp base, a support frame, a flame holder, a flame flake, a light-emitting body and a power supply; wherein the power supply being disposed inside the lamp base; the support frame being fixedly standing upon the lamp base; the flame holder being fixedly connected to the top of the support frame and having a vertical via hole; the flame flake penetrating the via hole and protruding beyond the top of the flame holder; the light-emitting body being fixed to the flame holder and emits light towards the direction of the flame flake; the light-emitting body being electrically connected to the power supply; the lamp stand with faux flame further comprising a driving device, an impact arm and a driving circuit, wherein the driving device being fixed to the lamp base; one end of the impact arm being connected to the output end of the driving device; the driving circuit and the power supply being electrically connected and driving the output end of the driving device to suck in or bounce out to generate a propulsion, which in turn making the impact arm to hit the flame flake.

2. The lamp stand with faux flame as claimed in claim 1, wherein the driving device is a relay or an electromagnetic coil.

3. The lamp stand with faux flame as claimed in claim 1, wherein the upper end of the impact arm is disposed with an impact head; when the impact arm hits the flame flake, the impact head contacts the power end of the flame flake to cause the flame flake to sway.

4. The lamp stand with faux flame as claimed in claim 1, wherein the impact arm hits the lower end of the flame flake intermittently.

5. The lamp stand with faux flame as claimed in claim 1, further comprising a lamp shade; wherein the lamp shape having an opening at the top; the lamp shade covering on the outside of the lamp base, the support frame and the flame holder; and the flame flake passing through the opening and extending beyond the lamp shade.
